(19) United States
(12) Patent Application Publication
(10) Pub. No.: US 2026/0318168 A1
(43) Pub. Date: Oct. 15, 2026

(54) SYSTEMS AND METHODS FOR INTERNAL FLUID FLOW BETWEEN MULTIPLE PISTONS IN ACTUATOR

(71) Applicant: Schlumberger Technology Corporation, Sugar Land, TX (US)

(72) Inventors: Florent Vargas, Beziers (FR); Mathieu Valls, BEZIERS CEDEX (FR); Jean-Luc Pujol, Beziers (FR)

(21) Appl. No.: 19/177,287

(22) Filed: Apr. 11, 2025

(51) Int. Cl. E21B 33/06

(52) U.S. Cl. CPC E21B 33/062

(57) ABSTRACT

A system includes a first actuator having a first piston disposed in a first fluid chamber in a first housing portion, a second piston disposed in a second fluid chamber in a second housing portion, and a first internal flow passage within the first actuator. The first internal flow passage enables fluid flow between the first and second fluid chambers on a first side of the first and second pistons to actuate the first and second pistons in a first axial direction

### BACKGROUND

The present disclosure relates generally to fluid-driven actuators, such as multi-piston actuators used for valves (e.g., blowout preventers (BOPs)).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Fluid-driven actuators may be used for a variety of valves, such as gate valves and BOPs in an oil and gas system. The fluid-driven actuators drive one or more valve elements (e.g., gates, rams, etc.) between open and closed positions to control fluid flow and/or fluid pressures. For example, BOPs may be used to close a well in response to a loss of control of formation fluids. The fluid-driven actuators may include one or more piston-cylinder assemblies responsive to a fluid pressure. Unfortunately, existing fluid-driven actuators use a variety of external piping to the piston-cylinder assemblies, e.g., between different piston-cylinder assemblies. The external piping complicates the design and creates potential leak paths that can hinder proper operation of the fluid-driven actuators. As a result, a need exists for internal flow passages between the different piston-cylinder assemblies, e.g., between different fluid chambers.

### BRIEF DESCRIPTION

This summary is provided to introduce a selection of concepts that are further described below in the detailed description. This summary is not intended to identify key or essential features of the claimed subject matter, nor is it intended to be used as an aid in determining or limiting the scope of the claimed subject matter as set forth in the claims.

In certain embodiments, a system includes a first actuator having a first piston disposed in a first fluid chamber in a first housing portion, a second piston disposed in a second fluid chamber in a second housing portion, and a first internal flow passage within the first actuator. The first internal flow passage enables fluid flow between the first and second fluid chambers on a first side of the first and second pistons to actuate the first and second pistons in a first axial direction.

In certain embodiments, a method includes supplying a first fluid flow through a first internal flow passage within a first actuator to provide actuation in a first axial direction. The first actuator includes a first piston disposed in a first fluid chamber in a first housing portion, a second piston disposed in a second fluid chamber in a second housing portion, and the first internal flow passage. The first internal flow passage enables fluid flow between the first and second fluid chambers on a first side of the first and second pistons to actuate the first and second pistons in the first axial direction.

In certain embodiments, a system includes a first valve configured to move between open and closed positions, and a first actuator coupled to the first valve. The first actuator includes a first piston disposed in a first fluid chamber in a first housing portion, a second piston disposed in a second fluid chamber in a second housing portion, and one or more internal flow passages within the first actuator. The one or more internal flow passages enable fluid flow between the first and second fluid chambers adjacent the first and second pistons to actuate the first and second pistons to move the first valve between the open and closed positions. The one or more internal flow passages are disposed in the first piston, the second piston, the first housing portion, the second housing portion, or any combination thereof.

### DRAWINGS

These and other features, aspects, and advantages of the present disclosure will become better understood when the following detailed description is read with reference to the accompanying drawings in which like characters represent like parts throughout the drawings, wherein:

FIG. 1 is a top view of an embodiment of a blowout preventer (BOP) having internal flow passages between fluid chambers having pistons;

FIG. 2 is a partial cross-sectional top view of an embodiment of the BOP of FIG. 1, illustrating an actuator at a start of an axial range of movement of a close valve operation using the internal flow passages;

FIG. 3 is a partial cross-sectional top view of an embodiment of the BOP of FIGS. 1 and 2, illustrating the actuator at an end of the axial range of movement of the close valve operation using the internal flow passages;

FIG. 4 is a partial cross-sectional top view of an embodiment of the BOP of FIG. 1, illustrating the actuator at a start of an axial range of movement of an open valve operation using the internal flow passages;

FIG. 5 is a partial cross-sectional top view of an embodiment of the BOP of FIGS. 1 and 4, illustrating the actuator at an end of the axial range of movement of the open valve operation using the internal flow passages;

FIG. 6 is a cross-sectional view of an embodiment of an actuator of the BOP of FIGS. 1-5, further illustrating internal flow passages within the actuator; and

FIG. 7 is a partial cross-sectional top view of an embodiment of the BOP of FIG. 1, illustrating the actuator having internal flow passages.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As discussed in detail below, the embodiments discussed in detail below include fluid-driven actuators having multiple pistons actuated via internal flow passages. The internal flow passages may be formed in piston heads, piston shafts, housing portions, or any combination thereof, of the fluid-driven actuators. As a result, the fluid-driven actuators may substantially reduce external conduits between fluid chambers used to actuate the multiple pistons, thereby substantially reducing the number of potential leak points. The fluid-driven actuators may be used in valves, and various fluid-driven equipment, such as oil and gas equipment, subsea equipment, drilling equipment, and so forth.

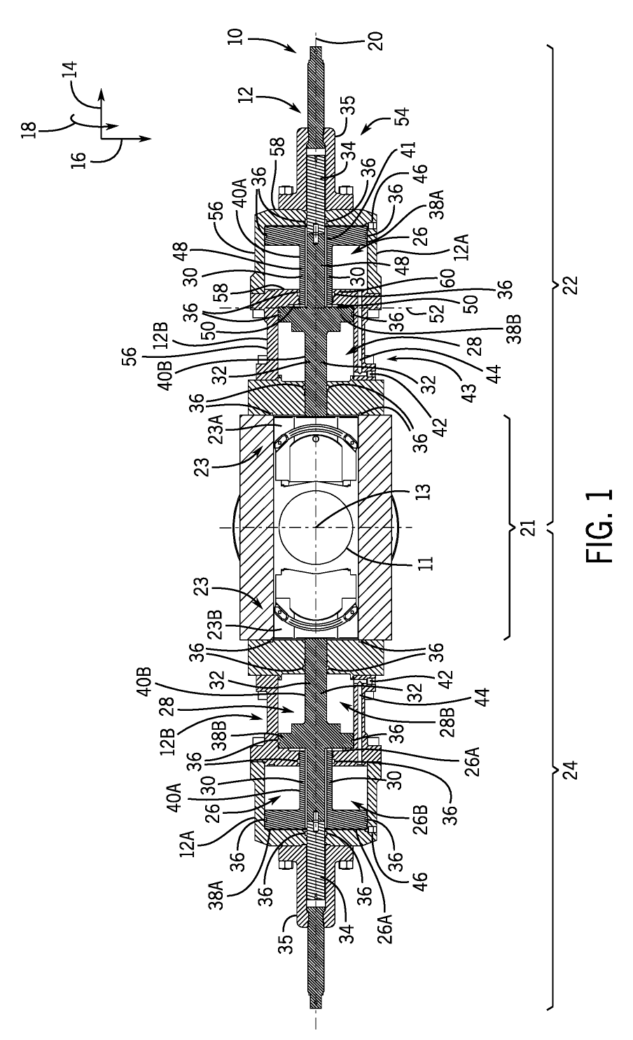

FIG. 1 is a top view of an embodiment of a blowout preventer (BOP) 10 coupled to a central bore 11 of a hydrocarbon extraction system (e.g., wellhead, Christmas tree, or the like). The BOP 10 may include a body or housing 12 formed from stainless steel, aluminum, or other suitable metals. The body or housing 12 may include or define a central valve portion 21 (e.g., BOP flow control portion) disposed between first and second actuators 22 and 24, wherein the central valve portion 21 is configured to open and close the central bore 11 in response to operation of the first and second actuators 22 and 24. As discussed in further detail below, the first and second actuators 22 and 24 include internal flow passages 43 to reduce the amount of external conduits associated with the first and second actuators 22 and 24.

For purposes of discussion, reference may be made to an axial direction or axis 14, a radial direction or axis 16 toward or away from the axial direction 14, and a circumferential direction or axis 18 circumferentially about the axial direction 14, wherein the directions or axes 14, 16, and 18 are defined relative to a central axis 20 of the BOP 10. For example, the axial direction 14 aligns with the central axis 20 of the BOP 10 in terms of actuation of the BOP 10 via first and second actuators 22 and 24, and the central axis 20 is crosswise (e.g., perpendicular) to a bore axis 13 of the central bore 11. The BOP 10 may be substantially symmetrical about the central bore 11, such that both the first actuator 22 and the second actuator 24 of the BOP 10 mirror each other.

In the illustrated embodiment, the first and second actuators 22 and 24 include fluid-driven actuators (e.g., hydraulic actuators) with a plurality of fluid chambers 26 and 28 (e.g., annular hydraulic chambers) internally coupled together within the first and second actuators 22 and 24, thereby substantially reducing external conduits associated with operation of the plurality of fluid chambers. Each of the first and second actuators 22 and 24 includes a piston 30 (e.g., annular piston) disposed in the fluid chamber 26 in the housing 12 (e.g., housing portion 12A) and a piston 32 (e.g., annular piston) disposed in the fluid chamber 28 in the housing 12 (e.g., housing portion 12B), wherein the fluid chambers 26 and 28 may receive fluid on either side of the pistons 30 and 32 for fluid actuation of the central valve portion 21. The housing portions 12A and 12B generally define cylinders or cylinder portions of the first and second actuators 22 and 24. In the illustrated embodiment, each of the housing portions 12A and 12B has a side wall 56 (e.g., annular side wall or cylinder wall) and an end wall 58 (e.g., axial end wall crosswise to the central axis 20). The end wall 58 of the housing portion 12B separates the fluid chambers 26 and 28. Accordingly, the housing portions 12A and 12B, the pistons 30 and 32, and the fluid chambers 26 and 28 collectively define piston-cylinder assemblies of the first and second actuators 22 and 24. As discussed in detail below, the pistons 30 and 32 are configured to move independently and/or together with one another via fluid actuation via various internal flow passages 43 in the first and second actuators 22 and 24.

The pistons 30 and 32 are coaxial with one another along the central axis 20, wherein the pistons 30 and 32 are configured to move axially while at least partially overlapping (e.g., axially overlapping portions) with one another in a concentric arrangement. In the illustrated embodiment, the piston 32 is coupled to a shaft 34 (e.g., tail rod) disposed within a valve bonnet 35, which is secured to the housing 12 via fasteners. For example, the valve bonnet 35 may be coupled to the housing portion 12A via fasteners (e.g., bolts), the housing portions 12A and 12B may be coupled together via fasteners (e.g., bolts), and the housing portion 12B may be coupled to the central valve portion 21 via fasteners (e.g., bolts). In some embodiments, the housing 12 may include a single housing or any number of housing portions for the first and second actuators 22 and 24 and the central valve portion 21. In the illustrated embodiment, the pistons 30 and 32 include a plurality of seals 36 (e.g., annular seals or O-rings) between outer annular surfaces of the pistons 30 and 32 and inner annular surfaces of the housing 12 (e.g., housing portions 12A and 12B). Each of the pistons 30 and 32 includes a piston head 38 coupled to a piston shaft 40, wherein the seals 36 are disposed about the piston head 38 and the piston shaft 40.

In the illustrated embodiment, the piston 30 includes a piston head 38A coupled to a piston shaft 40A, and the piston 32 includes a piston head 38B coupled to a piston shaft 40B. The piston shaft 40A extends axially away from the piston head 38A toward the piston head 38B in the inward direction toward the central bore 11. The piston shaft 40B extends in opposite axial directions away from the piston head 38B toward both the central valve portion 21 and the shaft 34. In particular, for each of the first and second actuators 22 and 24, the piston shaft 40B couples to a valve element 23 (e.g., 23A and 23B) of the central valve portion 21. In certain embodiments, the valve elements 23 may include valve rams (e.g., BOP rams) of the BOP 10. The piston shaft 40B of the piston 32 also extends through a central piston bore 41 (e.g., annular bore) within the piston 30 and couples with the shaft 34, collectively forming a shaft 54. The central piston bore 41 extends through both the piston head 38A and the piston shaft 40A of the piston 30. Additionally, the piston shaft 40A of the piston 30 extends through a piston bore 60 in the end wall 58 of the housing portion 12B.

The first and second actuators 22 and 24 further include fluid ports to enable fluid actuation of the pistons 30 and 32. For example, the fluid ports include an open port 42 and a close port 46. The fluid ports (e.g., 42 and 46) are further coupled to one or more internal flow passages 43 extending between the fluid chambers 26 and 28. In certain embodiments, the internal flow passages 43 may be disposed anywhere inside of the housing 12 (e.g., housing portions 12A and 12B), inside the pistons 30 and 32, between the pistons 30 and 32, or any combination thereof.

For example, the internal flow passages 43 include internal flow passages 44 in the housing 12, such as in the housing portions 12A and 12B. In the illustrated embodiment, the internal flow passage 44 extends through the housing portion 12B from the open port 42 fluidly coupled to the fluid chamber 28 to the fluid chamber 26. The internal flow passage 44 may include an axial flow passage, a radial flow passage, or any combination thereof. The internal flow passage 44 fluidly couples the fluid chambers 26 and 28 for an open valve operation (e.g., open valve elements 23) via fluid supplied via the open port 42 without any external conduits between the fluid chambers 26 and 28.

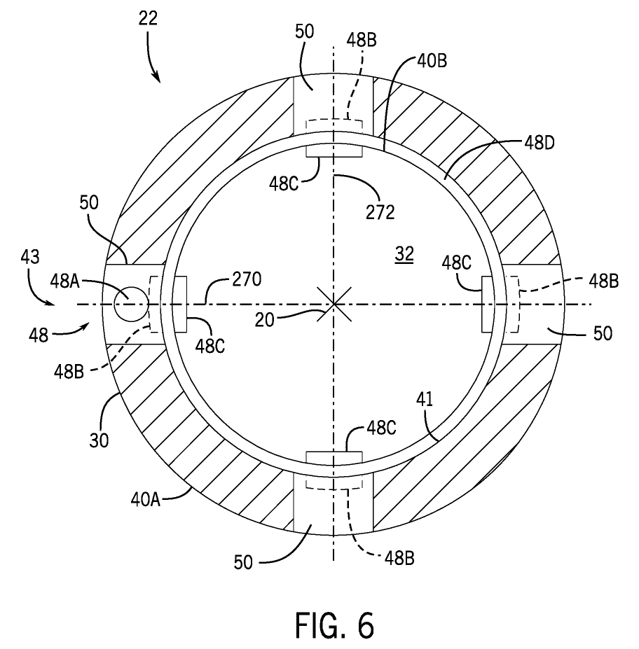

By further example, the internal flow passages 43 may include internal flow passages 48 formed in the piston 30, formed in the piston 32, between the pistons 30 and 32 (e.g., annular gap or space), or any combination thereof. In certain embodiments, the internal flow passages 48 may include axial slots or grooves along a surface of the piston 30 and/or the piston 32, such as along the central piston bore 41 and/or the piston shaft 40B. In certain embodiments, the internal flow passages 48 may include axial bores or conduits that are open only at opposite axial ends, such as at opposite axial ends of the piston 30. In certain embodiments, the internal flow passages 48 may include a single internal flow passage or a plurality of internal flow passages distributed circumferentially about the central axis 20. In certain embodiments, the internal flow passages 48 may include an annular internal flow passage directly between an outer annular surface of the piston shaft 40B and an inner annular surface of the piston shaft 40A (e.g., along the central piston bore 41). In other words, the internal flow passage 48 may be formed radially between the pistons 30 and 32, e.g., a space between axially overlapping portions of the pistons 30 and 32. The internal flow passages 48 may include an axial flow passage, a radial flow passage, or any combination thereof. The internal flow passages 48 may be formed in a cross-section 52 through the piston shafts 40A and 40B, as discussed in further detail below with reference to FIG. 6.

By further example, the internal flow passages 43 may include one or more internal flow passages 50 formed in the piston 30, formed in the piston 32, between the pistons 30 and 32 (e.g., axial gap or space), or any combination thereof. In certain embodiments, the internal flow passages 50 may include a radial flow passage, such as a radial groove or slot in an axially facing surface of the piston 30 or the piston 32, a radial bore or conduit through the piston shaft 40A of the piston 30, or any combination thereof. The internal flow passage 50 fluidly couples the internal flow passage 48 with the fluid chamber 28, while the internal flow passage 48 fluidly couples to the fluid chamber 26. Thus, the internal flow passages 48 and 50 fluidly couple the fluid chambers 26 and 28 for a close valve operation (e.g., close valve elements 23) via fluid supplied via the close port 46. However, a variety of configurations of internal flow passages 43 (e.g., 44, 48, and 50) are within the scope of the present embodiments. In certain embodiments, the first and second actuators 22 and 24 exclude any external conduits extending between the fluid chambers 26 and 28, such that the only fluid communication between the fluid chambers 26 and 28 occurs via the internal flow passages 43 (e.g., 44 and 48).

The first and second actuators 22 and 24 are configured to move the valve elements 23 (e.g., BOP rams) between open and closed valve positions via supply of a working fluid (e.g., hydraulic fluid) to one of the fluid ports (e.g., 42, 46). For example, an open valve operation can be achieved by supplying the working fluid through the open port 42 and the internal flow passage 44, enabling the working fluid to fill and pressurize the fluid chambers 26 and 28 on a first side of the piston heads 38A and 38B. The working fluid supplied to the first side of the piston heads 38A and 38B drives the pistons 30 and 32 and the valve elements 23 in a first axial direction away from the central bore 11. The movement of the valve elements 23 in the first axial direction transitions the central valve portion 21 of the BOP 10 from a closed valve position to an open valve position. By further example, a close valve operation can be achieved by supplying the working fluid through the close port 46 and the internal flow passages 48 and 50, enabling the working fluid to fill and pressurize the fluid chambers 26 and 28 on a second side of the piston heads 38A and 38B. The working fluid supplied to the second side of the piston heads 38A and 38B drives the pistons 30 and 32 and the valve elements 23 in a second axial direction toward from the central bore 11. The movement of the valve elements 23 in the second axial direction transitions the central valve portion 21 of the BOP 10 from the open valve position to the close valve position. Thus, aside from the fluid ports (e.g., 42, 46), the actuation of the pistons 30 and 32 is achieved internally within the first and second actuators 22 and 24 via the internal flow passages 43 (e.g., 44, 48, and 50).

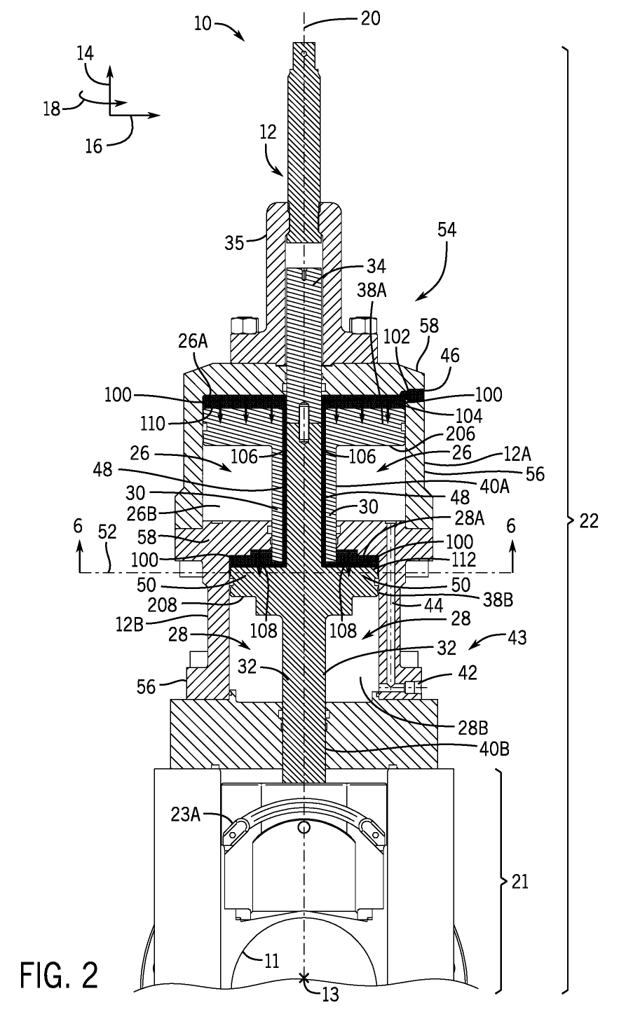

FIG. 2 is a partial cross-sectional top view of an embodiment of the BOP 10 of FIG. 1, illustrating a start of a close valve operation using the internal flow passages 43. Although FIG. 2 illustrates the first actuator 22, the following discussion applies to each of the first and second actuators 22 and 24. As illustrated, the fluid chamber 26 includes fluid chambers 26A and 26B on opposite sides of the piston head 38A of the piston 30, and the fluid chamber 28 includes fluid chambers 28A and 28B on opposite sides of the piston head 38B of the piston 32. Close fluid 100 may enter the first actuator 22 via the close port 46. The close fluid 100 may be any hydraulic fluid, such as a hydraulic oil or a water-based fluid (e.g., fresh water, antifreeze, and corrosion inhibitors). The close fluid 100 may flow along a flow path 102 into the fluid chamber 26 (e.g., fluid chamber 26A) axially outward of the piston 30 (e.g., piston head 38A). As the close fluid 100 enters the fluid chamber 26A, the close fluid 100 may exert a force 104 on a piston face 110 of the piston 30 (e.g., piston head 38A) along the axial direction towards the central valve portion 21. The force 104 may actuate the piston 30 towards the central valve portion 21 of the BOP 10. As the close fluid 100 exerts force on the piston 30, the close fluid may also follow a flow path 106 through the internal flow passages 48 and 50 towards the fluid chamber 28.

As discussed above, the internal flow passage 48 generally extends in an axial direction, and the internal flow passage 50 generally extends in a radial direction. In the illustrated embodiment, the internal flow passage 48 may be formed in the piston 30, formed in the piston 32, between the pistons 30 and 32 (e.g., annular gap or space), or any combination thereof. In certain embodiments, the internal flow passages 48 may include axial slots or grooves along a surface of the piston 30 and/or the piston 32, such as along the central piston bore 41 and/or the piston shaft 40B. The internal flow passage 50 may be formed in the piston 30, formed in the piston 32, between the pistons 30 and 32 (e.g., axial gap or space), or any combination thereof. In certain embodiments, the internal flow passage 50 may include a radial flow passage, such as a radial groove or slot in an axially facing surface of the piston 30 or the piston 32, a radial bore or conduit through the piston shaft 40A of the piston 30, or any combination thereof.

As the close fluid 100 exits the internal flow passages 48 and 50, the close fluid 100 pressurizes the fluid chamber 28A and exerts an axial force 108 on a piston face 112 of the piston 32 (e.g., piston head 38B) in an inward axial direction toward the central valve portion 21. The axial force 108 may also be bolstered by the actuation of the piston 30, as the piston 30 is configured to press the piston shaft 40A against the piston face 112 of the piston head 38B of the piston 32. As such, the actuation of the piston 30 may exert pressure on and assist with actuating the piston 32. In this manner, the internal flow passages 48 and 50 enable the close fluid 100 to simultaneously pressurize the fluid chambers 26A and 28A to drive the pistons 30 and 32 in the inward axial direction to move the valve elements 23 of the central valve portion 21 from an open valve position to a closed valve position.

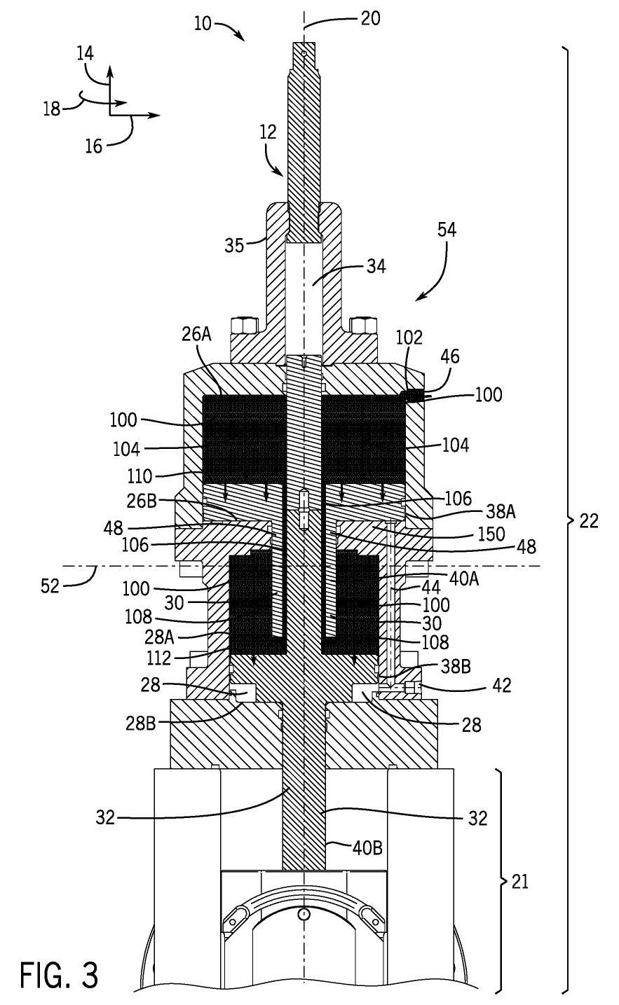

FIG. 3 is a partial cross-sectional top view of an embodiment of the BOP 10 of FIGS. 1 and 2, illustrating an end of the axial range of movement of the close valve operation using the internal flow passages 43. FIG. 3 is substantially the same as discussed above with reference to FIGS. 1 and 2, except that the close fluid 100 has driven both pistons 30 and 32 in the inward axial direction to close the valve elements 23 of the central valve portion 21. As illustrated in FIG. 3, the close fluid 100 continues to fill, pressurize, and expand the fluid chambers 26A and 28A, which are fluidly coupled together via the internal flow passages 48 and 50. In particular, the close fluid 100 flows along the flow path 106 through the internal flow passages 48 and 50. As the fluid chambers 26A and 28A expand, the pistons 30 and 32 move in the inward axial direction to move the valve elements 23 of the central valve portion 21 from an open valve position to a closed valve position. Additionally, the fluid within the fluid chambers 26B and 28B may vent or discharge through the open port 42 and the internal flow passage 44, while the fluid chambers 26B and 28B gradually contract or reduce in volume due to the movement of the pistons 30 and 32. Eventually, the piston 30 has actuated until it reaches the housing edge 150 of the end wall 58, which blocks the piston 30 from actuating further.

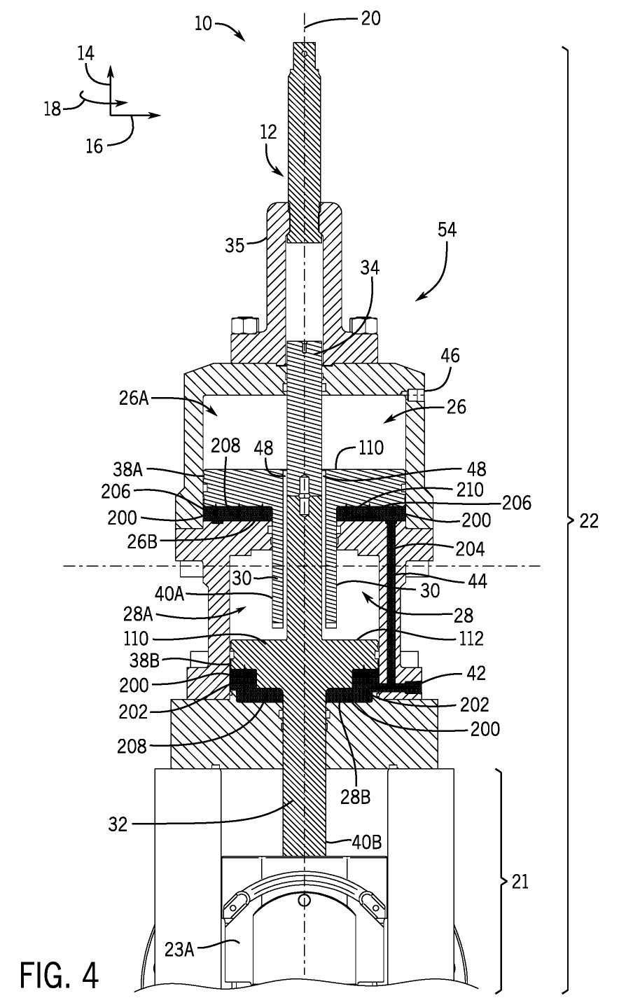

FIG. 4 is a partial cross-sectional top view of an embodiment of the BOP 10 of FIG. 1, illustrating a start of an axial range of movement of an open valve operation using the internal flow passages 43. Although FIG. 4 illustrates the first actuator 22, the following discussion applies to each of the first and second actuators 22 and 24. Open fluid 200 may enter along a flow path 250 through the open port 42 and flow into the first actuator 22. The open fluid 200 may be the same as the close fluid 100. As the open fluid 200 enters the first actuator 22, the open fluid 200 flows into and pressurizes the fluid chamber 28B axially inward of the piston 32 (e.g., piston head 38B), thereby applying an outward axial force 202 on a piston face 208 of the piston head 38B. At the same time, the open fluid 200 flows internally through the first actuator 22 along a flow path 204 through the internal flow passage 44 from the open port 42 to the fluid chamber 26. In particular, the internal flow passage 44 fluidly couples the fluid chambers 28B and 26B, such that the open fluid 200 flows into and pressurizes the fluid chamber 26B axially inward of the piston 30 (e.g., piston head 38A). The fluid pressure of the open fluid 200 in the fluid chamber 26B applies an outward axial force 210 on a piston face 206 of the piston head 38A. Together, the open fluid 200 in the fluid chambers 26B and 28B hydraulically drives an outward axial movement of the piston heads 38A and 38B of the pistons 30 and 32, thereby moving the valve elements 23 of the central valve portion 21 from the closed valve position to the open valve position.

As noted above, the internal flow passage 44 is formed internally in the housing 12, such as in the housing portions 12A and/or 12B. In the illustrated embodiment, the internal flow passage 44 extends through the housing portion 12B from the open port 42 fluidly coupled to the fluid chamber 28B to the fluid chamber 26B. The internal flow passage 44 may include an axial flow passage, a radial flow passage, or any combination thereof, in the side wall 56 and the end wall 58 of the housing portion 12B. Thus, the internal flow passage 44 fluidly couples the fluid chambers 26B and 28B for the open valve operation (e.g., open valve elements 23) via fluid supplied via the open port 42 without any external conduits between the fluid chambers 26B and 28B.

As the open fluid 200 pressurizes the fluid chambers 26B and 28B, the piston heads 38A and 38B of the pistons 30 and 32 move in the outward axial direction, resulting in an expansion or increase in volume of the fluid chambers 26B and 28B and a contraction or decrease in volume of the fluid chambers 26A and 28A. The pistons 30 and 32 are configured to actuate and move independently from one another. However, the pistons 30 and 32 combine axial forces 202 and 210 via an engagement between the pistons 30 and 32, as the piston head 38B of the piston 32 contacts an axial distal end of the piston shaft 40A of the piston 30. In this manner, the internal flow passage 44 enables the open fluid 200 to simultaneously pressurize the fluid chambers 26B and 28B to drive the pistons 30 and 32 in the outward axial direction to move the valve elements 23 of the central valve portion 21 from the closed valve position to the open valve position.

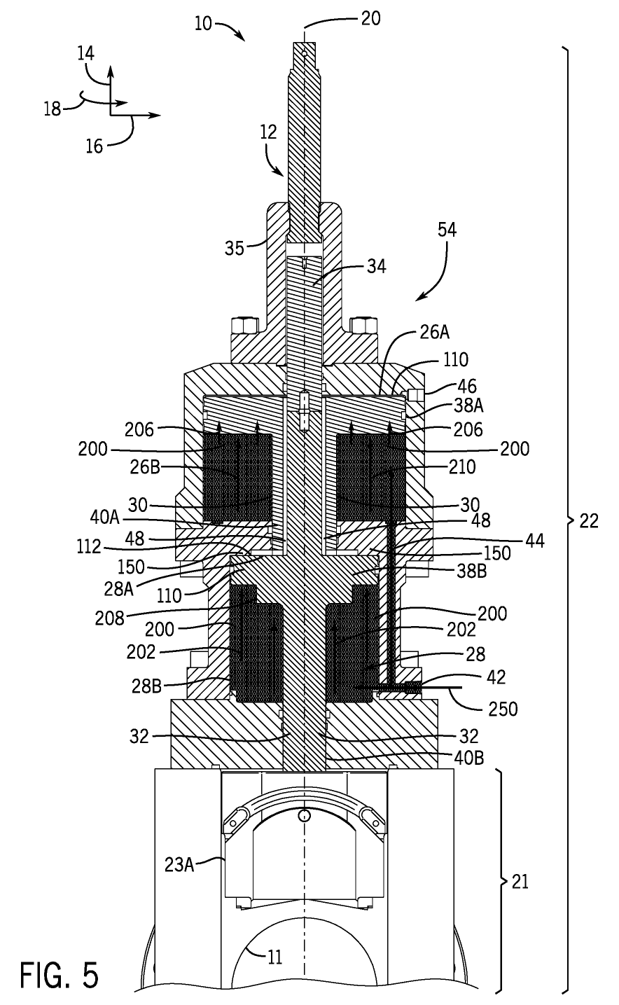

FIG. 5 is a partial cross-sectional top view of an embodiment of the BOP 10 of FIGS. 1 and 4, illustrating an end of the axial range of movement of the open valve operation using the internal flow passages 43. FIG. 5 is substantially the same as discussed above with reference to FIGS. 1-4, except that the open fluid 200 has driven both pistons 30 and 32 in the outward axial direction to open the valve elements 23 of the central valve portion 21. As illustrated in FIG. 5, the open fluid 200 continues to fill, pressurize, and expand the fluid chambers 26B and 28B, which are fluidly coupled together via the internal flow passage 44. In particular, the open fluid 200 flows along the flow path 204 through the internal flow passage 44. As the fluid chambers 26B and 28B expand, the pistons 30 and 32 move in the outward axial direction to move the valve elements 23 of the central valve portion 21 from the closed valve position to the open valve position. Additionally, the fluid within the fluid chambers 26A and 28A may vent or discharge through the close port 46 and the internal flow passage 44, while the fluid chambers 26A and 28A gradually contract or reduce in volume due to the movement of the pistons 30 and 32. Eventually, the pistons 30 and 32 move in the outward axial direction until the piston heads 38A and 38B reach the end wall 58 of the housing portions 12A and 12B, which block further movement of the pistons 30 and 32 in the outward axial direction. Additionally, the shaft 34 moves in the outward axial direction into the valve bonnet 35. Again, the internal flow passage 44 enables the open fluid 200 to fill, pressurize, and expand the fluid chambers 26B and 28B without any external conduits between the fluid chambers 26B and 28B.

FIG. 6 is a cross-sectional view of an embodiment of an actuator of the BOP 10 of FIGS. 1-5 taken along line 6-6 of FIG. 2, further illustrating internal flow passages within the actuator. Although FIG. 6 illustrates an embodiment of the first actuator 22, the following discussion applies to each of the first and second actuators 22 and 24. As illustrated in FIG. 6, the internal flow passages 43 may include one or more of the internal flow passages 48 and 50 formed in the piston 30, formed in the piston 32, and/or formed between the pistons 30 and 32.

In certain embodiments, the internal flow passages 48 may include one or more axial bores 48A within the piston 30, including within the piston shaft 40A and the piston head 38A of the piston 30. By further example, the internal flow passages 48 may include one or more axial grooves or slots 48B along an inner annular surface of the piston 30 (e.g., central piston bore 41 through the piston shaft 40A and the piston head 38A), one or more axial grooves or slots 48C along an outer annular surface of the piston 32 (e.g., the piston shaft 40B), an annular passage 48D (e.g., annular clearance gap) between the inner annular surface of the piston 30 and the outer annular surface of the piston 32, or any combination thereof. These internal flow passages 48 (e.g., 48A, 48B, 48C, and/or 48D) may be used completely alone or in any suitable combination. For embodiments with the annular passage 48D, the radial clearance may be sized to provide the desired flow rate between the fluid chambers 26 and 28. These internal flow passages 48 further couple to the internal flow passages 50.

In certain embodiments, the internal flow passages 50 include radial flow passages, such as radial bores, radial slots or grooves, or any combination thereof. For example, the internal flow passages 50 may include radial slots or grooves formed in a distal axial end of the piston shaft 40A of the piston 30, radial slots or grooves formed in the piston face 112 of the piston head 38B of the piston 32, or any combination thereof. By further example, the internal flow passages 50 may include radial bores formed in the piston shaft 40A of the piston 30 (e.g., offset away from the distal axial end of the piston shaft 40A), internal bores formed in the piston head 38B of the piston 32, or any combination thereof.

In the illustrated embodiment, the internal flow passages 48 and 50 may be arranged relative to axes or planes 270 and 272 intersecting the central axis 20 and oriented perpendicular to one another, thereby defining four 90 degree quadrants. For example, the internal flow passages 48 and 50 may include four internal flow passages 48 and 50 aligned with the axes 270 and 272. However, in certain embodiments, the internal flow passages 48 and 50 may include any number (e.g., 1, 2, 3, 4, 5, 6, 7, 8, 9, 10, or more), shape, and arrangement of internal flow passages 48 and 50 (e.g., uniformly or non-uniformly distributed about the central axis 20). For example, the internal flow passages 48 and 50 may include bores, slots, or grooves having a shape that is circular, square, rectangular, triangular, or any combination thereof. In some embodiments, the internal flow passages 48 may be equidistant from each other, while in other embodiments, the internal flow passages 48 may be spread out in an unequal configuration based on the configuration of the pistons, the chambers, and the like. In some embodiments, the internal flow passages 50 may be equidistant from each other, while in other embodiments, the internal flow passages 50 may be spread out in an unequal configuration based on the configuration of the pistons, the chambers, and the like.

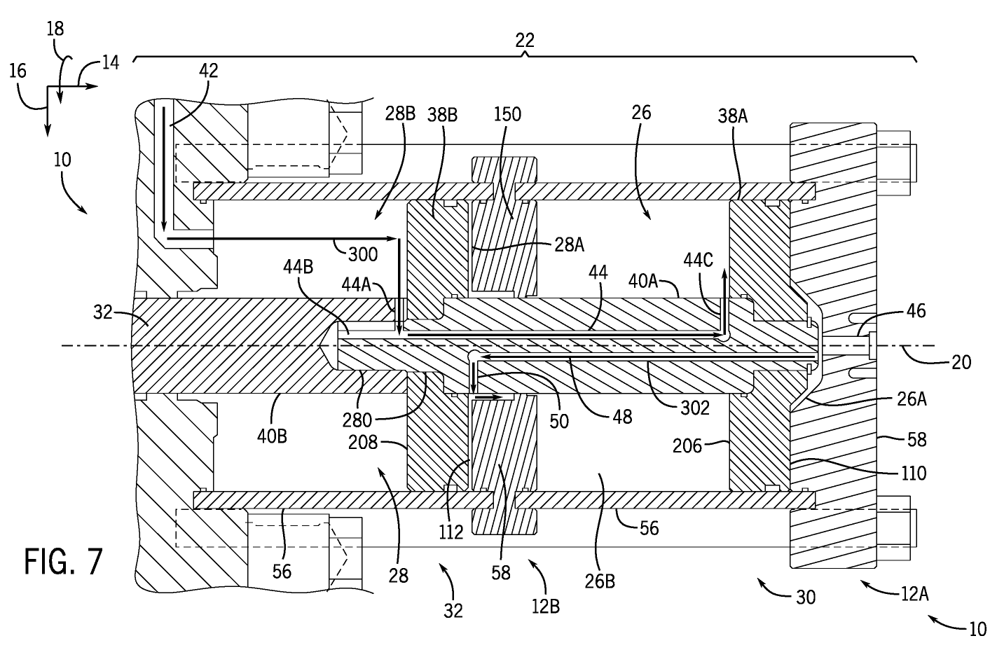

FIG. 7 is a partial cross-sectional top view of an embodiment of the BOP 10 of FIG. 1, illustrating an actuator having internal flow passages 43. Although FIG. 7 illustrates an embodiment of the first actuator 22, the following discussion applies to each of the first and second actuators 22 and 24. In the illustrated embodiment, the piston 30 has the piston head 38A coupled to the piston shaft 40A via one or more fasteners. Similarly, the piston 32 has the piston head 38B coupled to the piston shaft 40B via one or more fasteners. In certain embodiments, the piston shaft 40A of the piston 30 is coupled to the piston 32 (e.g., at piston head 38B and/or piston shaft 40B) via one or more fasteners. The fasteners used for the various connections may include a threaded interface between the parts, threaded fasteners (e.g., bolts), retainer clips and/or pins, and/or a fixed connection (e.g., welded joint). In some embodiments, the piston shaft 40A of the piston 30 is configured to move freely in and out of a central bore in the piston 32 (e.g., at piston head 38B and/or piston shaft 40B), such that the pistons 30 and 32 can move independently from one another.

In the illustrated embodiment, the internal flow passages 43 (e.g., 44, 48, and 50) are formed in the piston shafts 40A and 40B. For example, the internal flow passage 44 includes a radial passage 44A in the piston shaft 40B, an axial passage 44B in the piston shaft 40A, and a radial passage 44C in the piston shaft 40A, wherein the internal flow passages 44 (e.g., 44A, 44B, and 44C) enable fluid flow between the fluid chambers 26B and 28B for an open valve operation. Thus, in contrast to the embodiment of FIGS. 2-6, the embodiment of FIG. 7 has the internal flow passages 44 in the piston shafts 40A and 40B rather than the housing portion 12B. By further example, the internal flow passages 48 and 50 include axial and radial passages in the piston shaft 40A, wherein the internal flow passages 48 and 50 enable fluid flow between the fluid chambers 26A and 28A for a close valve operation.

The internal flow passages 43 (e.g., 44, 48, and 50) receive fluid via one of the ports 42 and 46. In the illustrated embodiment, the close port 46 is disposed in a central location along the central axis 20, particularly in the end wall 58 of the housing portion 12A. The close port 46 generally has a central axial bore or fluid port. The open port 42 is disposed in the housing portion 12B. The open port 42 generally has both axial and radial bores to define the fluid port. The internal flow passages 43 (e.g., 44, 48, and 50) are generally offset and separate from the open and close ports 42 and 46. Thus, the internal flow passages 43 (e.g., 44, 48, and 50) generally exchange fluid between the fluid chambers 26 and 28 after the fluid is supplied by the open and close ports 42 and 46 to the fluid chambers 26 and 28.

The first and second actuators 22 and 24 are configured to move the valve elements 23 (e.g., BOP rams) between open and closed valve positions via supply of a working fluid (e.g., hydraulic fluid) to one of the fluid ports (e.g., 42, 46). For example, an open valve operation can be achieved by supplying the working fluid through the open port 42 and the internal flow passage 44 along a flow path 300, enabling the working fluid to fill and pressurize the fluid chambers 26B and 28B on a first side of the piston heads 38A and 38B. The working fluid supplied to the first side of the piston heads 38A and 38B drives the pistons 30 and 32 and the valve elements 23 in a first axial direction away from the central bore 11. The movement of the valve elements 23 in the first axial direction transitions the central valve portion 21 of the BOP 10 from a closed valve position to an open valve position. By further example, a close valve operation can be achieved by supplying the working fluid through the close port 46 and the internal flow passages 48 and 50 along a flow path 302, enabling the working fluid to fill and pressurize the fluid chambers 26A and 28A on a second side of the piston heads 38A and 38B. The working fluid supplied to the second side of the piston heads 38A and 38B drives the pistons 30 and 32 and the valve elements 23 in a second axial direction toward from the central bore 11. The movement of the valve elements 23 in the second axial direction transitions the central valve portion 21 of the BOP 10 from the open valve position to the close valve position. Thus, aside from the fluid ports (e.g., 42, 46), the actuation of the pistons 30 and 32 is achieved internally within the first and second actuators 22 and 24 via the internal flow passages 43 (e.g., 44, 48, and 50).

The technical effects of the disclosed embodiments include internal flow passages 43 (e.g., 44, 48, and 50) formed within the actuators 22 and 24, thereby substantially reducing external conduits and potential leak paths. The actuators 22 and 24 having the internal flow passages 43 (e.g., 44, 48, and 50) may be used for any fluid-driven actuators used with flow control equipment or valves, such as gate valves, ball valves, BOPs 10, and the like. However, the actuators 22 and 24 having the internal flow passages 43 (e.g., 44, 48, and 50) may be used for any fluid-driven equipment, such as oil and gas equipment, wellsite equipment, drilling equipment, or any combination thereof, associated with the extraction of fluids (e.g., hydrocarbons) from a subterranean reservoir. For example, the actuators 22 and 24 having the internal flow passages 43 (e.g., 44, 48, and 50) may be used with various subsea equipment, including BOPs, wellheads, Christmas trees, subsea fluid distribution systems, and the like.

The subject matter described in detail above may be defined by one or more clauses, as set forth below.

A system includes a first actuator having a first piston disposed in a first fluid chamber in a first housing portion, a second piston disposed in a second fluid chamber in a second housing portion, and a first internal flow passage within the first actuator. The first internal flow passage enables fluid flow between the first and second fluid chambers on a first side of the first and second pistons to actuate the first and second pistons in a first axial direction.

The system of the preceding clause, including a first valve coupled to and driven by the first actuator.

The system of any preceding clause, including a blowout preventer (BOP) having the first actuator coupled to the first valve.

The system of any preceding clause, including a second actuator having a third piston disposed in a third fluid chamber in a third housing portion, a fourth piston disposed in a fourth fluid chamber in a fourth housing portion, and one or more internal flow passages within the second actuator. The one or more internal flow passages enable fluid flow between the first and second fluid chambers to actuate the first and second pistons. The system further includes a second valve coupled to and driven by the second actuator, wherein the BOP includes the first and second valves.

The system of any preceding clause, including a second internal flow passage within the first actuator, wherein the second internal flow passage enables fluid flow between the first and second fluid chambers on a second side of the first and second pistons to actuate the first and second pistons in a second axial direction opposite to the first axial direction.

The system of any preceding clause, wherein the first and second internal flow passages are disposed in the first piston, the second piston, the first housing portion, the second housing portion, or a combination thereof.

The system of any preceding clause, including a first port coupled to the first housing portion and a second port coupled to the second housing portion, wherein the first port is in fluid communication with the first internal flow passage, and the second port is in fluid communication with the second internal flow passage.

The system of any preceding clause, wherein the first internal flow passage extends through the first piston, the second piston, or a space between axially overlapping portions of the first and second pistons.

The system of any preceding clause, wherein the second internal flow passage extends through the second housing portion.

The system of any preceding clause, wherein each of the first and second internal flow passages extends through the first piston, the second piston, or a combination thereof.

The system of claim 1, wherein the first piston includes a first piston head coupled to a first piston shaft, the second piston includes a second piston head coupled to a second piston shaft, and the second piston shaft extends at least partially through a central piston bore in the first piston.

The system of any preceding clause, wherein the first internal flow passage includes an axial bore or an axial groove in the first piston along the first piston head and the first piston shaft.

The system of any preceding clause, wherein the first internal flow passage includes a radial bore or a radial groove in the first piston along the first piston shaft.

The system of any preceding clause, wherein the first actuator excludes external conduits extending between the first and second fluid chambers.

A method includes supplying a first fluid flow through a first internal flow passage within a first actuator to provide actuation in a first axial direction. The first actuator includes a first piston disposed in a first fluid chamber in a first housing portion, a second piston disposed in a second fluid chamber in a second housing portion, and the first internal flow passage. The first internal flow passage enables fluid flow between the first and second fluid chambers on a first side of the first and second pistons to actuate the first and second pistons in the first axial direction.

The method of the preceding clause, including supplying a second fluid flow through a second internal flow passage within the first actuator to provide actuation in a second axial direction opposite to the first axial direction. The second internal flow passage enables fluid flow between the first and second fluid chambers on a second side of the first and second pistons to actuate the first and second pistons in the second axial direction.

The method of any preceding clause, including actuating a first valve via the actuation in the first axial direction and the second axial direction.

A system includes a first valve configured to move between open and closed positions, and a first actuator coupled to the first valve. The first actuator includes a first piston disposed in a first fluid chamber in a first housing portion, a second piston disposed in a second fluid chamber in a second housing portion, and one or more internal flow passage within the first actuator. The one or more internal flow passage enable fluid flow between the first and second fluid chambers adjacent the first and second pistons to actuate the first and second pistons to move the first valve between the open and closed positions. The one or more internal flow passages are disposed in the first piston, the second piston, the first housing portion, the second housing portion, or any combination thereof.

The system of the preceding clause, including a blowout preventer (BOP) having the first valve and the first actuator.

The system of any preceding clause, wherein the first actuator excludes external conduits extending between the first and second fluid chambers.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising
a first actuator, comprising:
a first piston disposed in a first fluid chamber in a first housing portion;
a second piston disposed in a second fluid chamber in a second housing portion; and
a first internal flow passage within the first actuator, wherein the first internal flow passage enables fluid flow between the first and second fluid chambers on a first side of the first and second pistons to actuate the first and second pistons in a first axial direction.

2. The system of claim 1, comprising a first valve coupled to and driven by the first actuator.

3. The system of claim 2, comprising a blowout preventer (BOP) having the first actuator coupled to the first valve.

4. The system of claim 3, comprising:
a second actuator, comprising:
a third piston disposed in a third fluid chamber in a third housing portion;
a fourth piston disposed in a fourth fluid chamber in a fourth housing portion; and
one or more internal flow passages within the second actuator, wherein the one or more internal flow passages enable fluid flow between the third and fourth fluid chambers to actuate the third and fourth pistons; and
a second valve coupled to and driven by the second actuator, wherein the BOP comprises the first and second valves.

5. The system of claim 1, comprising a second internal flow passage within the first actuator, wherein the second internal flow passage enables fluid flow between the first and second fluid chambers on a second side of the first and second pistons to actuate the first and second pistons in a second axial direction opposite to the first axial direction.

6. The system of claim 5, wherein the first and second internal flow passages are disposed in the first piston, the second piston, the first housing portion, the second housing portion, or a combination thereof.

7. The system of claim 5, comprising a first port coupled to the first housing portion and a second port coupled to the second housing portion, wherein the first port is in fluid communication with the first internal flow passage, and the second port is in fluid communication with the second internal flow passage.

8. The system of claim 5, wherein the first internal flow passage extends through the first piston, the second piston, or a space between axially overlapping portions of the first and second pistons.

9. The system of claim 8, wherein the second internal flow passage extends through the second housing portion.

10. The system of claim 5, wherein each of the first and second internal flow passages extends through the first piston, the second piston, or a combination thereof.

11. The system of claim 1, wherein the first piston comprises a first piston head coupled to a first piston shaft, the second piston comprises a second piston head coupled to a second piston shaft, and the second piston shaft extends at least partially through a central piston bore in the first piston.

12. The system of claim 11, wherein the first internal flow passage comprises an axial bore or an axial groove in the first piston along the first piston head and the first piston shaft.

13. The system of claim 12, wherein the first internal flow passage comprises a radial bore or a radial groove in the first piston along the first piston shaft.

14. The system of claim 1, wherein the first actuator excludes external conduits extending between the first and second fluid chambers.

15. A method, comprising:
supplying a first fluid flow through a first internal flow passage within a first actuator to provide actuation in a first axial direction, wherein the first actuator comprises a first piston disposed in a first fluid chamber in a first housing portion, a second piston disposed in a second fluid chamber in a second housing portion, and the first internal flow passage, wherein the first internal flow passage enables fluid flow between the first and second fluid chambers on a first side of the first and second pistons to actuate the first and second pistons in the first axial direction.

16. The method of claim 15, comprising:
supplying a second fluid flow through a second internal flow passage within the first actuator to provide actuation in a second axial direction opposite to the first axial direction, wherein the second internal flow passage enables fluid flow between the first and second fluid chambers on a second side of the first and second pistons to actuate the first and second pistons in the second axial direction.

17. The method of claim 16, comprising actuating a first valve via the actuation in the first axial direction and the second axial direction.

18. A system, comprising:
a first valve configured to move between open and closed positions; and
a first actuator coupled to the first valve, wherein the first actuator comprises:
a first piston disposed in a first fluid chamber in a first housing portion;
a second piston disposed in a second fluid chamber in a second housing portion; and
one or more internal flow passages within the first actuator, wherein the one or more internal flow passages enable fluid flow between the first and second fluid chambers adjacent the first and second pistons to actuate the first and second pistons to move the first valve between the open and closed positions, wherein the one or more internal flow passages are disposed in the first piston, the second piston, the first housing portion, the second housing portion, or any combination thereof.

19. The system of claim 18, comprising a blowout preventer (BOP) having the first valve and the first actuator.

20. The system of claim 18, wherein the first actuator excludes external conduits extending between the first and second fluid chambers.
